(19) United States
(12) Patent Application Publication
(10) Pub. No.: US 2025/0180517 A1
(43) Pub. Date: Jun. 5, 2025

(54) COMPUTER-IMPLEMENTED METHOD FOR DETERMINING DEPTH AND LOCATION OF LOCALISED THINNING IN PLATE STRUCTURE

(71) Applicant: AGENCY FOR SCIENCE, TECHNOLOGY AND RESEARCH, Singapore (SG)

(72) Inventors: Voon Kean WONG, Singapore (SG); Shuting CHEN, Singapore (SG); Kui YAO, Singapore (SG)

(21) Appl. No.: 18/838,741

(22) PCT Filed: Feb. 17, 2023
(86) PCT No.: PCT/SG2023/050093

§ 371 Date: Aug. 15, 2024

(30) Foreign Application Priority Data
Feb. 25, 2022 (SG) 10202201929Q

(51) Int. Cl. G01N 29/04; G01N 29/07; G01N 29/44

(52) U.S. Cl. CPC G01N 29/041; G01N 29/07; G01N 29/4409; G01N 2291/02854; G01N 2291/0289; G01N 2291/2632

(57) ABSTRACT

A computer-implemented method (10) for determining depth and location of localised thinning in a plate structure is provided. The computer-implemented method (10) for determining depth and location of localised thinning in the plate structure includes executing on one or more processors the steps of: selecting (12) a high-order symmetric Lamb wave mode; generating (14) the selected high-order symmetric Lamb wave mode in the plate structure using one or more first ultrasonic transducers attached to the plate structure; detecting (16) the generated high-order symmetric Lamb wave mode using the 0 one or more first ultrasonic transducers or one or more second ultrasonic transducers attached to the plate structure; comparing (18) arrival times of the detected high-order symmetric Lamb wave mode with a set of baseline signals to determine the depth of the localised thinning in the plate structure; and analysing (20) the arrival times of the detected high-order symmetric Lamb wave mode reflected from an edge of the localised thinning to determine the location of the localised thinning in the plate structure.

### FIELD OF THE INVENTION

The present invention relates in general to corrosion inspection and more particularly to a computer-implemented method for determining depth and location of localised thinning in a plate structure.

### BACKGROUND OF THE INVENTION

Changes in plate thicknesses may occur due to corrosion from long periods of exposure to corrosive substances. Corrosion is an issue of concern across all industrial fields. Structural components affected by corrosion exhibit gradual loss of material and this lower structural integrity, which ultimately causes failure of the structural components.

Corrosion inspection tools have been developed to inspect and monitor corrosion in structures. Commercially available corrosion inspection systems typically perform corrosion inspection by point-by-point measurements such as, for example, using ultrasonic probes. As most structural sections affected by corrosion are concealed and inaccessible without removal of parts, such corrosion inspection techniques are labour intensive, inefficient, and prone to human error and accessibility issues.

In view of the foregoing, it would be desirable to provide a computer-implemented method for determining depth and location of localised thinning in a plate structure that addresses one or more of the above issues.

### SUMMARY OF THE INVENTION

Accordingly, in a first aspect, the present invention provides a computer-implemented method for determining depth and location of localised thinning in a plate structure. The computer-implemented method for determining depth and location of localised thinning in the plate structure includes executing on one or more processors the steps of: selecting a high-order symmetric Lamb wave mode; generating the selected high-order symmetric Lamb wave mode in the plate structure using one or more first ultrasonic transducers attached to the plate structure; detecting the generated high-order symmetric Lamb wave mode using the one or more first ultrasonic transducers or one or more second ultrasonic transducers attached to the plate structure; comparing arrival times of the detected high-order symmetric Lamb wave mode with a set of baseline signals to determine the depth of the localised thinning in the plate structure; and analysing the arrival times of the detected high-order symmetric Lamb wave mode reflected from an edge of the localised thinning to determine the location of the localised thinning in the plate structure.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1A is a schematic flow diagram illustrating a computer-implemented method for determining depth and location of localised thinning in a plate structure in accordance with an embodiment of the present invention;

FIG. 1B is a schematic block diagram illustrating a computer system suitable for implementing the method for determining depth and location of localised thinning in the plate structure disclosed herein;

FIG. 2A is a schematic diagram illustrating first and second ultrasonic transducers operating in pitch-catch working mode in a thinning area of a plate structure;

FIGS. 2B and 2C are graphs of Lamb wave dispersion curves of an aluminium alloy plate;

FIG. 2D is a graph of experimental and theoretical curves for absolute time delay against relative reduction of plate thickness;

FIG. 2E is a graph of experimental results showing arrival time of the fastest wavelet at each relative reduction of thickness;

FIG. 2F is a schematic diagram illustrating use of pulse-echo working mode of an ultrasonic transducer on a plate structure for determining location of localized thinning;

FIG. 2G is a graph of experimental results showing arrival times of a reflected S4 mode from a localized thinning edge of the plate structure of FIG. 2F at different relative thickness reductions;

FIG. 2H is a schematic diagram illustrating combination of both pitch-catch and pulse-echo working modes using a pair of ultrasonic transducers to determine depth and location of localized thinning;

FIG. 3A is a schematic diagram illustrating working modes of a plurality of ultrasonic transducers for determination of depth and location of localized thinning on a large plate structure;

FIG. 3B is a photograph showing dimensions of an aluminium alloy plate and eight (8) ultrasonic transducer elements;

FIG. 3C is a photograph illustrating pulse-echo working mode using ultrasonic transducer element number 4 of FIG. 3B as an example;

FIG. 3D is a B-scan image showing reflections of a localized thinning edge in t1 and reflections from the edge of the plate in t2 by performing sequential pulse-echo working mode on all the ultrasonic transducer elements in the array of FIG. 3B;

FIG. 4 is a schematic diagram illustrating a linear ultrasonic transducer array on a long plate; and

FIG. 5 is a schematic diagram illustrating a concentric ultrasonic transducer array on a plate structure.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “symmetric Lamb wave mode” as used herein refers to a type of ultrasonic elastic wave that propagates along and is guided by a solid plate structure, the ultrasonic elastic wave having displacement motion along a thickness direction of the solid plate structure and symmetry with respect to a midplane of the solid plate structure. Accordingly, the term “high-order symmetric Lamb wave mode” as used herein refers to the symmetric Lamb wave mode (Sn) having a mode number n that is equal to or greater than one (1) such as, for example, S1, S2 and S3.

The term “dispersion” as used herein relates wavelength or wavenumber of a Lamb wave to its frequency. Given this dispersion relation, phase velocity and group velocity of waves in a medium as a function of frequency may be calculated. The group velocity of a wave is a velocity at which an overall envelope shape of an amplitude of the wave travels through a structure and the phase velocity of the wave is a velocity at which a phase of any one frequency component of the wave travels. The term “dispersion curves” as used herein refers to a set of curves that relate phase and group velocities as different domains of Lamb wave modes to a product of Lamb wave mode frequency and plate thickness. Accordingly, the term “group velocity dispersion curves” as used herein refers to a set of curves that relate the group velocities of the Lamb wave modes to the product of Lamb wave mode frequency and plate thickness.

The term “pulse-echo working mode” as used herein refers to application of an ultrasonic transducer for generation of ultrasonic waves and detection of the ultrasonic waves reflected from an edge of localized thinning or a plate structure by the same ultrasonic transducer.

The term “pitch-catch working mode” as used herein refers to application of a first ultrasonic transducer for generation of ultrasonic waves and detection of the ultrasonic waves by one or more second ultrasonic transducers.

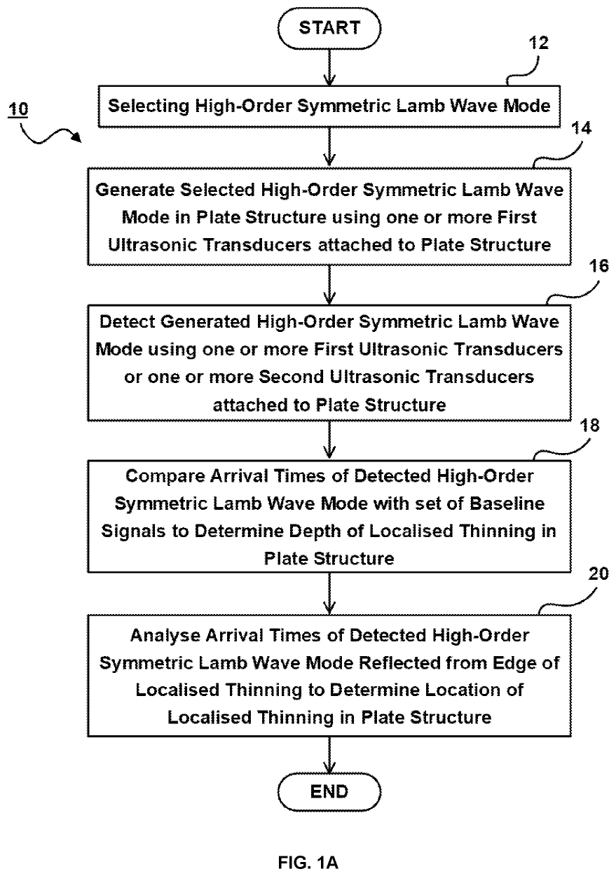

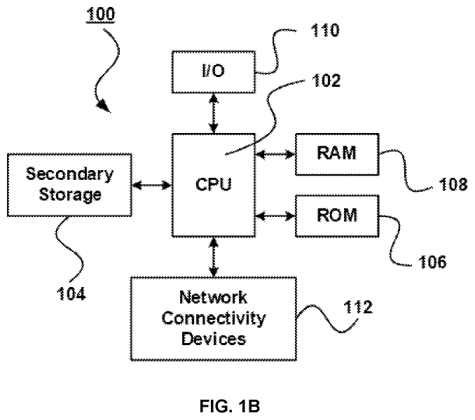

Referring now to FIG. 1A, a computer-implemented method 10 for determining depth and location of localised thinning in a plate structure is shown. The method 10 for determining depth and location of localised thinning in the plate structure may be executed on one or more processors.

The method 10 begins at step 12 by selecting a high-order symmetric (Sn) Lamb wave mode. Advantageously, as ultrasonic Lamb waves are able to propagate over a long distance with low attenuation, the method 10 may be used for corrosion inspection or monitoring of a large area. Further advantageously, as high-order symmetric Lamb wave mode have shorter wavelengths compared to fundamental Lamb wave modes (S0 and A0 modes), this increases sensitivity of the method 10 to small defects in the plate structure and reduces footprint required to implement the method 10. The high-order symmetric Lamb wave mode to be selected may be S1, S2, S3, S4 or higher.

Ultrasonic Lamb waves are dispersive with their phase velocity and group velocity depending on the frequency-thickness product. These relations are described by dispersion curves. Accordingly, the step 12 of selecting the high-order symmetric Lamb wave mode may include obtaining group velocity dispersion curves of Lamb wave modes based on plate material and plate thickness. Group velocity of the high-order symmetric Lamb wave mode is dependent on the thickness of the plate structure. When the selected high-order symmetric Lamb wave mode enters a localized thinned area, its group velocity changes according to the group velocity dispersion curve. Once the selected high-order symmetric Lamb wave mode exits the thinned area, its group velocity reverts to its original group velocity. Therefore, depth and location of the localized reduction of plate thickness may be estimated by analysing change in time-of-arrival of the selected high-order symmetric Lamb wave mode. The phase velocity and group velocity dispersion curves of Lamb wave modes may be obtained for plate structures with known thicknesses.

To avoid signals overlapping by Lamb wave modes with lower group velocity, a Lamb wave mode with highest group velocity may be selected. Accordingly, the step 12 of selecting the high-order symmetric Lamb wave mode may also include determining fastest group velocities from the group velocity dispersion curves of the plate structure. High-order symmetric Lamb wave modes are selected because their group velocity is the highest at respective frequency-thickness products according to the group velocity dispersion curves.

The high-order symmetric Lamb wave mode may be selected based on the frequency with fastest group velocity determined from the group velocity dispersion curve. Accordingly, the step 12 of selecting the high-order symmetric Lamb wave mode may further include selecting a frequency for the high-order symmetric Lamb wave mode based on or corresponding to the fastest group velocities from the group velocity dispersion curves of the plate structure. Selection of the high-order symmetric Lamb wave mode may be based on wavelength and operation frequency corresponding to the fastest group velocity of the selected high-order symmetric Lamb wave mode.

At step 14, the selected high-order symmetric Lamb wave mode is generated in the plate structure using one or more first ultrasonic transducers attached to the plate structure.

At step 16, the generated high-order symmetric Lamb wave mode is detected using the one or more first ultrasonic transducers or one or more second ultrasonic transducers attached to the plate structure.

The one or more first ultrasonic transducers and/or the one or more second ultrasonic transducers may be bonded or in-situ fabricated on the surface of the plate structure. Accordingly, the selected high-order symmetric Lamb wave mode may be generated and/or detected by one or more ultrasonic transducers that are bonded or in-situ fabricated on one (1) single surface of the plate. The one or more ultrasonic transducers may include piezoelectric material such as, for example, piezoelectric polymer and electrode layers. Advantageously, piezoelectric ultrasonic transducers are highly conformable and the use of high-order symmetric Lamb wave modes in the method 10 decreases transducer size due to corresponding smaller wavelengths. This allows the method 10 to be applied to structures with limited surface area for transducer installation.

One of the electrode layers may be comb-shaped and the periodicity of the comb shape may correspond to the wavelength of the selected high-order symmetric Lamb wave mode to enhance generation and detection of the selected high-order symmetric Lamb wave mode. Accordingly, a wavelength of the selected high-order symmetric Lamb wave mode may correspond to a periodicity of a comb-shaped electrode of at least one of the one or more first ultrasonic transducers and the one or more second ultrasonic transducers. Advantageously, the use in the method 10 of ultrasonic transducers with patterned electrodes increases and enhances excitability and detectability of Lamb wave modes.

At step 18, arrival times of the detected high-order symmetric Lamb wave mode are compared with a set of baseline signals to determine the depth of the localised thinning in the plate structure. The set of baseline signals are ultrasonic signals that are obtained from a pristine plate structure, either through theoretical calculation or experimental measurement, when the plate structure has no localized thinning. The depth of the localized thinning may be estimated or determined by comparing the arrival time of the selected high-order symmetric Lamb wave mode with a pre-determined baseline signal.

The step 18 of comparing the arrival times of the detected high-order symmetric Lamb wave mode with the set of baseline signals may include generating the set of baseline signals representing an initial state of the plate structure. More particularly, at least one set of baseline signals may be generated to represent the initial state of the plate structure using pitch-catch and/or pulse-echo working modes.

The step of generating the baseline signal may include applying electrical driving signals at a selected frequency to the one or more first ultrasonic transducers attached to the plate structure to generate a plurality of high-order symmetric Lamb waves in the selected high-order symmetric Lamb wave mode. High-order symmetric Lamb waves may be generated by applying electrical driving signals with the selected frequency to an ultrasonic transducer.

The step of generating the baseline signal may also include detecting the high-order symmetric Lamb waves at the one or more first ultrasonic transducers via a pulse-echo working mode.

The step of generating the baseline signal may further include detecting the high-order symmetric Lamb waves at the one or more second ultrasonic transducers via a pitch-catch working mode.

The high-order symmetric Lamb waves are received by the same or another ultrasonic transducer via pitch-catch and pulse-echo working modes, respectively. In the pitch-catch working mode, the transmitting and the receiving ultrasonic transducers are separated by a predetermined distance, also known as separation distance, from centre-to-centre of the two ultrasonic transducers.

Ultrasonic signals at different states of the plate structure may be obtained by repeating the high-order symmetric Lamb waves generation and receiving procedures described above using the pitch-catch working mode and the pulse-echo working mode.

The ultrasonic transducers in the pitch-catch working mode are configured so that the high-order symmetric Lamb waves are generated from one ultrasonic transducer, pass by and/or through the localized thinning region, and are subsequently detected by another ultrasonic transducer. In the pitch-catch working mode, the transmitting ultrasonic transducers and the receiving ultrasonic transducers may have a predetermined separation distance between centres of the two transducers. Arrival time of the high-order symmetric Lamb waves is affected by the depth of localized thinning. Depth of the localized thinning may be estimated by comparing the arrival time of the selected high-order symmetric Lamb wave mode with the pre-determined baseline signal using pitch-catch working mode.

At step 20, the arrival times of the detected high-order symmetric Lamb wave mode reflected from an edge of the localised thinning are analysed to determine the location of the localised thinning in the plate structure. More particularly, the location of the localized thinning may be determined by analysing arrival time of the selected high-order symmetric Lamb wave mode reflected from the edge of the localized thinning. This may be performed using the pulse-echo working mode. Accordingly, the location of the localized thinning may be determined by the ultrasonic signal obtained in the pulse-echo working mode. Location of the localized thinning may be determined by analyzing arrival time of the selected high-order Lamb wave mode reflected from the edge of the localized thinning using pulse-echo working mode.

In the method 10, depth and location of localized thinning may be determined by analysing the ultrasonic signal related to the arrival time of the selected high-order symmetric Lamb wave mode via pitch-catch and pulse-echo working modes, respectively. Ultrasonic signals obtained using the pitch-catch working mode at different states of the plate structure are compared with the pre-determined baseline signal to determine the depth of the localised thinning. For determination of the location of the localised thinning, the baseline signal is not used. Instead, the high-order symmetric Lamb wave mode reflected from an edge of the localised thinning is analysed; ultrasonic signals obtained using the pulse-echo working mode are used to determine location of the localized thinning. The high-order symmetric Lamb wave mode may be generated and/or detected by a single ultrasonic transducer or by multiple ultrasonic transducers working in pitch catch or pulse-echo working mode. In one or more embodiments, a combination of pitch-catch and pulse-echo working modes may both be applied using a pair of ultrasonic transducers to estimate localized thinning depth and location of the localized thinning from the ultrasonic transducer pair. The ultrasonic transducers may form a linear array using a combination of pitch-catch and pulse-echo working modes for determining depth and location of multiple localized thinning of a large plate structure. For example, the first ultrasonic transducers and the second ultrasonic transducers may be arranged to form one or more linear arrays on the plate structure. In one or more other embodiments, the ultrasonic transducers may form a concentric array using pitch-catch and pulse-echo working modes for determining depth and location of multiple localized thinning of a large plate structure. For example, the second ultrasonic transducers may be arranged to form a concentric array on the plate structure.

Referring now to FIG. 1B, a computer system 100 suitable for implementing the method 10 for determining depth and location of localised thinning in a plate structure is shown. The computer system 100 includes a processor 102 (which may be referred to as a central processor unit or CPU) that is in communication with memory devices including secondary storage 104, read only memory (ROM) 106, random access memory (RAM) 108, input/output (I/O) devices 110, and network connectivity devices 112. The processor 102 may be implemented as one or more CPU chips.

It is understood that by programming and/or loading executable instructions onto the computer system 100, at least one of the CPU 102, the RAM 108, and the ROM 106 are changed, transforming the computer system 100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 100 is turned on or booted, the CPU 102 may execute a computer program or application. For example, the CPU 102 may execute software or firmware stored in the ROM 106 or stored in the RAM 108. In some cases, on boot and/or when the application is initiated, the CPU 102 may copy the application or portions of the application from the secondary storage 104 to the RAM 108 or to memory space within the CPU 102 itself, and the CPU 102 may then execute instructions that the application is comprised of. In some cases, the CPU 102 may copy the application or portions of the application from memory accessed via the network connectivity devices 112 or via the I/O devices 110 to the RAM 108 or to memory space within the CPU 102, and the CPU 102 may then execute instructions that the application is comprised of. During execution, an application may load instructions into the CPU 102, for example load some of the instructions of the application into a cache of the CPU 102. In some contexts, an application that is executed may be said to configure the CPU 102 to do something, for example, to configure the CPU 102 to perform the function or functions promoted by the subject application. When the CPU 102 is configured in this way by the application, the CPU 102 becomes a specific purpose computer or a specific purpose machine.

The secondary storage 104 is typically comprised of one or more disk drives or tape drives and is used for non-volatile storage of data and as an over-flow data storage device if RAM 108 is not large enough to hold all working data. Secondary storage 104 may be used to store programs which are loaded into RAM 108 when such programs are selected for execution. The ROM 106 is used to store instructions and perhaps data which are read during program execution. ROM 106 is a non-volatile memory device which typically has a small memory capacity relative to the larger memory capacity of secondary storage 104. The RAM 108 is used to store volatile data and perhaps to store instructions. Access to both ROM 106 and RAM 108 is typically faster than to secondary storage 104. The secondary storage 104, the RAM 108, and/or the ROM 106 may be referred to in some contexts as computer readable storage media and/or non-transitory computer readable media.

I/O devices 110 may include cameras, printers, video monitors, liquid crystal displays (LCDs), plasma displays, touch screen displays, keyboards, keypads, switches, dials, mice, track balls, voice recognizers, card readers, paper tape readers, or other well-known input devices. The network connectivity devices 112 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WIMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the above-described method steps. Such information, which is often represented as a sequence of instructions to be executed using processor 102, may be received from and outputted to the network, for example, in the form of a computer data signal embodied in a carrier wave. Such information, which may include data or instructions to be executed using processor 102 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 102 executes instructions, codes, computer programs, scripts which it accesses from hard disk, floppy disk, optical disk (these various disk-based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 104, for example, hard drives, floppy disks, optical disks, and/or other device, the ROM 106, and/or the RAM 108 may be referred to in some contexts as non-transitory instructions and/or non-transitory information.

In an embodiment, the computer system 100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 100 to provide the functionality of a number of servers that is not directly bound to the number of computers in the computer system 100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 100, at least portions of the contents of the computer program product to the secondary storage 104, to the ROM 106, to the RAM 108, and/or to other non-volatile memory and volatile memory of the computer system 100. The processor 102 may process the executable instructions and/or data structures in part by directly accessing the computer program product, for example by reading from a CD-ROM disk inserted into a disk drive peripheral of the computer system 100. Alternatively, the processor 102 may process the executable instructions and/or data structures by remotely accessing the computer program product, for example by downloading the executable instructions and/or data structures from a remote server through the network connectivity devices 112. The computer program product may comprise instructions that promote the loading and/or copying of data, data structures, files, and/or executable instructions to the secondary storage 104, to the ROM 106, to the RAM 108, and/or to other non-volatile memory and volatile memory of the computer system 100.

In some contexts, the secondary storage 104, the ROM 106, and the RAM 108 may be referred to as a non-transitory computer readable medium or a computer readable storage media. A dynamic RAM embodiment of the RAM 108, likewise, may be referred to as a non-transitory computer readable medium in that while the dynamic RAM receives electrical power and is operated in accordance with its design, for example during a period of time during which the computer system 100 is turned on and operational, the dynamic RAM stores information that is written to it. Similarly, the processor 102 may comprise an internal RAM, an internal ROM, a cache memory, and/or other internal non-transitory storage blocks, sections, or components that may be referred to in some contexts as non-transitory computer readable media or computer readable storage media.

### EXAMPLES

### Example 1

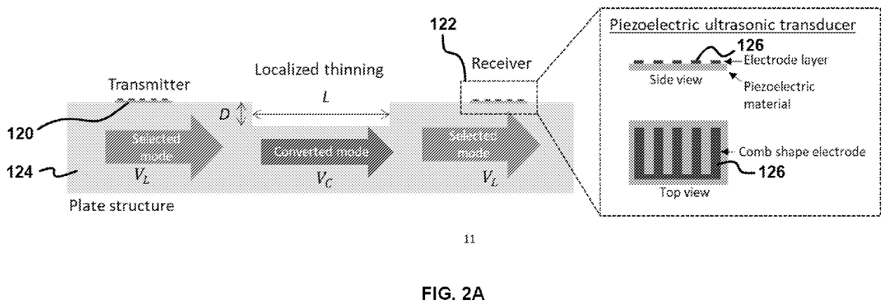

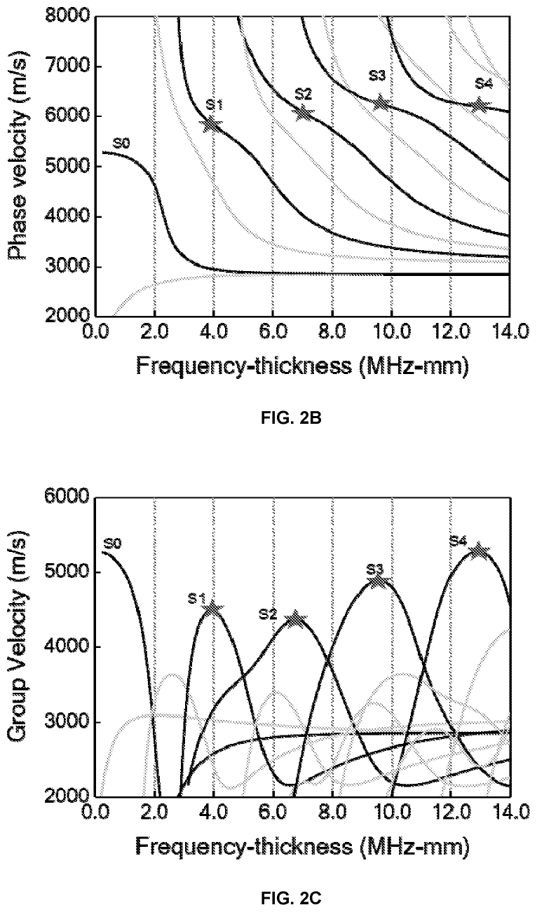

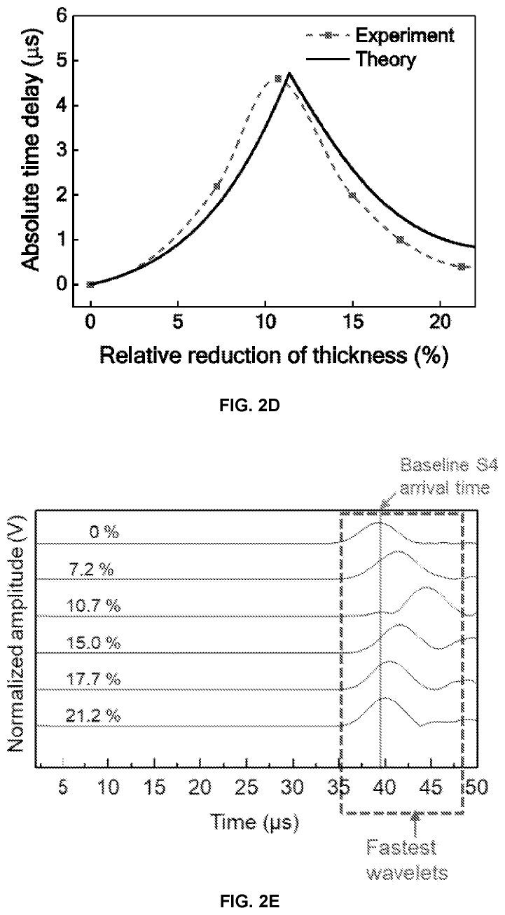

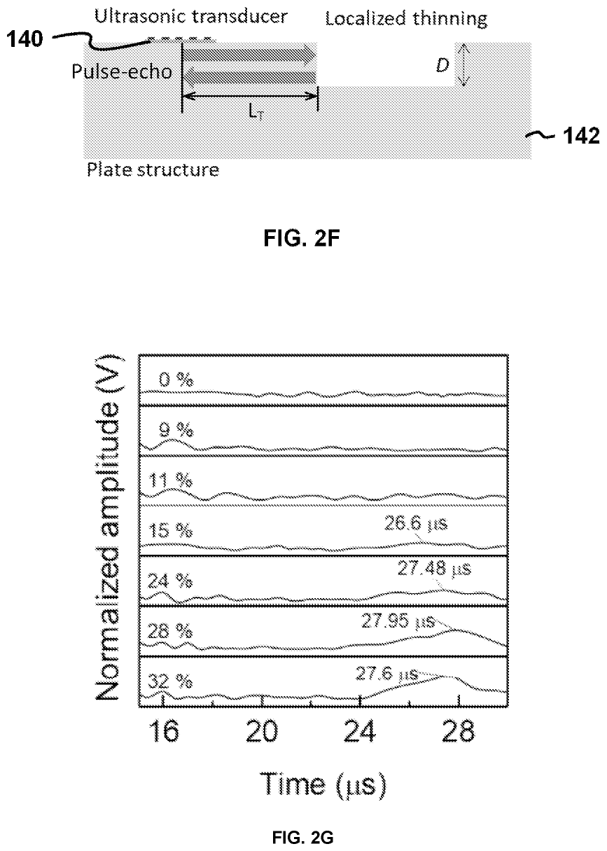

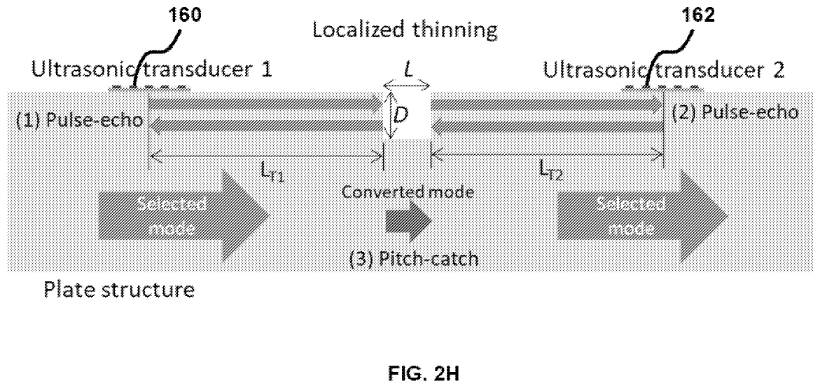

Referring now to FIG. 2A, first and second ultrasonic transducers 120 and 122 operating in pitch-catch working mode in a thinning area of a plate structure 124 is shown. In this example, a method for determining depth and location of localized thinning of the plate structure 124 with high-order symmetric Lamb wave is demonstrated. In FIG. 2A, L represents a length of a thinning area, V_{L} represents group velocity of a selected high-order symmetric Lamb wave mode in a region without localized thinning, and V_{SC} represents group velocity of a fastest mode converted high-order symmetric Lamb wave mode in a region with localized thinning.

To demonstrate a method for selection of high-order symmetric Lamb wave mode, the pair of piezoelectric ultrasonic transducers 120 and 122 are bonded on the aluminium alloy plate 124 with thickness of 2.56 mm. High-order symmetric Lamb wave mode S4, with highest group velocity of 5205 m/s, is generated at a frequency of 4.9 MHZ. Main considerations when selecting a high-order symmetric Lamb wave mode for this method are its wavelength and frequency. Not only does the selection of the wavelength and frequency affect a smallest depth to be detected, it also determines the size of the ultrasonic transducers 120 and 122.

The piezoelectric ultrasonic transducers 120 and 122 were designed with one of the electrode layers 126 in a comb shape for generation and detection of the S4 mode effectively. By using the electrode layer 126 in comb shape, the high-order symmetric Lamb wave mode selectivity is enhanced. The electrode layers 126 in comb shape are designed with periodicity according to wavelength of the selected high-order symmetric Lamb wave mode. Comb-shaped electrode width may be calculated using Equation (1) below:

$$d = \frac{λ}{2} = \frac{{v}_{p}}{2 f} \qquad ( 1 )$$

where λ represents wavelength of a selected ultrasonic guided wave mode; vₚ represents a phase velocity of the selected high-order symmetric Lamb wave mode; and f represents excitation frequency of the selected high-order symmetric Lamb wave mode.

A comparison of overall sensor length for fundamental Lamb wave mode design (S0) and high-order symmetric Lamb wave mode design (S4) is tabulated in Table 1 below.

TABLE 1
Sensor length comparison for fundamental mode design (S0) and
selected high-order symmetric Lamb wave mode design (S4)

| | | | | | | Total |
|---|---|---|---|---|---|---|
| | | Phase | Wave- | Electrode | | sensor |
| | Frequency | velocity | length | width | No. of | length |
| Design | (MHz) | (m/s) | (mm) | (mm) | electrode | (mm) |
| S0 | 0.74 | 4742 | 6.41 | 3.20 | 11 | 32.04 |
| S4 | 4.90 | 6245 | 1.27 | 0.64 | 11 | 6.37 |

As can be seen from Table 1 above, given the same number of electrodes (comb fingers), the high-order symmetric Lamb wave mode design is five times shorter than S0 mode design.

For determining the depth of localized thinning, the ultrasonic transducers 120 and 122 are configured to pitch-catch working mode for generation and detection of the selected high-order symmetric Lamb wave mode. In this configuration, the selected high-order symmetric Lamb wave mode is generated by one ultrasonic transducer 120, passes by a localized thinning region and is detected by another ultrasonic transducer 122 as shown in FIG. 2A.

Separation distance between ultrasonic transmitter 120 and ultrasonic receiver 122 in pitch-catch working mode is also an important consideration in actual implementation of a corrosion monitoring system. Separation distance defines the centre-to-centre gap between the two ultrasonic transducers 120 and 122 arranged in pitch-catch working mode. A minimum separation distance may be estimated using Equations (2) and (3) below:

$$S {D}_{min} = 2 {t}_{EMI} \times {V}_{g} \qquad ( 2 )$$

$${t}_{EMI} = \frac{n}{f} \qquad ( 3 )$$

where V_{g} represents group velocity of the selected high-order symmetric Lamb wave mode; t_{EMI} represents a time period of electromagnetic interference (EMI) caused by an excitation signal; and n represents a number of cycles of the excitation signal. The EMI period is multiplied by 2 to cater for possible ringing from the ultrasonic transducers 120 and 122.

A comparison of minimum separation distance required for fundamental mode design (S0) and the selected high-order symmetric Lamb wave mode design (S4) are tabulated in Table 2 below.

TABLE 2
Separation distance of ultrasonic transducers
for fundamental mode design (S0) and selected
high-order symmetric Lamb wave mode design (S4)

| | | | | Minimum |
|---|---|---|---|---|
| | Frequency | Group velocity | EMI period | separation |
| Design | (MHz) | (m/s) | (μs) | distance (mm) |
| S0 | 0.74 | 3280 | 20.27 | 8.86 |
| S4 | 4.90 | 5205 | 3.06 | 2.12 |

As can be seen from Table 2 above, the minimum separation distance per excitation cycle required for the proposed high-order symmetric ultrasonic guided wave mode design is 4.15 times shorter than the S0 mode design.

Referring now to FIGS. 2B and 2C, Lamb wave dispersion curves of an aluminium alloy plate are shown. More particularly, phase velocity dispersion curves of the aluminium alloy plate are shown in FIG. 2B and group velocity dispersion curves of the aluminium alloy plate are shown in FIG. 2C. Lamb wave modes with highest group velocity are selected. Selections of high-order symmetric Lamb wave modes are marked with a star in FIGS. 2B and 2C. Examples of selected Lamb wave modes with highest group velocity at respective frequency-thickness products are shown in FIG. 2C such as, for example, S1 mode at 3.9 MHz-mm, S2 mode at 6.7 MHz-mm, S3 mode at 9.5 MHz-mm and S4 mode at 12.9 MHz-mm.

According to the group velocity dispersion curves in FIG. 2C, group velocity of the propagating Lamb wave is dependent on the thickness of the plate structure 124. When the selected high-order symmetric Lamb wave mode (S4) enters the localized thinned area, mode conversion occurs. The converted mode (SC) will have different group velocity, which is dependent on the thickness of the plate structure 124, based on the group velocity dispersion curve. Once SC mode exits the thinned area, it is converted back to S4 mode. The change in arrival time of S4-SC-S4 can be monitored and variation in thickness can be estimated using Equations (4) and (5) below:

$$Δ t = L ( \frac{1}{{V}_{L}} - \frac{1}{{V}_{C}} ) \qquad ( 4 )$$

$$D = pristine thickness - remaining thickness \qquad ( 5 )$$

where Δt represents a delay of the selected high-order symmetric Lamb wave mode caused by thickness reduction; L represents a corroded zone length; V_{L} represents group velocity of the selected high-order symmetric Lamb wave mode in pristine zone; D represents a corroded zone depth; and V_{C}(D) represents group velocity of the converted Lamb wave mode with highest group velocity in the corroded zone, which is a function of the corroded zone depth, D.

Referring now to FIG. 2D, experimental and theoretical curves for absolute time delay against relative reduction of plate thickness are shown. Using Equation (4) and the high-order symmetric Lamb wave mode with the fastest group velocity according to the group velocity dispersion curve in FIG. 2C, the theoretical change in arrival time against relative thickness reduction graph can be plotted as shown in FIG. 2D.

Referring now to FIG. 2E, experimental results showing arrival time of the fastest wavelet at each relative reduction of thickness are shown. To simulate reduction of plate thickness, a slot with length and width of 63 mm and 28 mm, respectively, was machined. The slot was machined progressively with increasing depth. After each machining iteration, ultrasonic testing was conducted. This was done by providing a 5-cycle sine wave electrical driving excitation signal with frequency of 4.9 MHz to generate S4 mode with the ultrasonic transmitter. The arrival time of the fastest wave mode was detected by the ultrasonic transducer as shown in FIG. 2E.

Referring again to FIG. 2D, the arrival time of the transmitted S4-SC-S4 mode is subtracted to the baseline S4 arrival time to obtain the absolute time delay. Experimental curve for absolute time delay against relative reduction of plate thickness can be plotted thereafter, as presented in FIG. 2D.

Referring now to FIG. 2F, use of pulse-echo working mode of an ultrasonic transducer 140 on a plate structure 142 for determining location of localized thinning is shown. Location of the localized thinning is next determined by the high-order symmetric Lamb wave ultrasonic signal obtained in pulse-echo working mode. The location of the localized thinning is determined by analysing arrival time of the selected high-order symmetric Lamb wave mode reflected from the edge of the localized thinning as presented in FIG. 2F. Experimental work was carried out to demonstrate this example. The ultrasonic transducer 140 was bonded on the aluminium alloy plate 142 with thickness of 2.56 mm. High-order symmetric Lamb wave mode S4 with the highest group velocity of 5205 m/s was generated at frequency of 4.9 MHz. Ultrasonic testing using pulse-echo working mode was conducted each time after increasing the depth of the localized thinning (D) via milling. The distance between the edge of the localized thinning and the centre of the ultrasonic transducer, L_{T}, was approximately 70 mm. The estimated arrival time for the reflected S4 mode was calculated to be approximately 26.90 μs.

Referring now to FIG. 2G, experimental results of arrival times of the reflected S4 mode from the localized thinning edge with different relative thickness reductions are shown. From the experimental results presented in FIG. 2G, the reflected S4 mode from the edge of the localized thinning was detected by the ultrasonic transducer 140 as the relative thickness reduction reached beyond 15%. Once arrival time for the S4 mode was detected, the distance L_{T} between the localized thinning edge and a centre of the ultrasonic transducer 140 may be estimated by applying Equation (6) below:

$${L}_{T} = 0.5 \times {V}_{S 4} \times t \qquad ( 6 )$$

wherein V_{S4} represents group velocity of the S4 mode and t represents arrival time of the S4 mode that is reflected from the edge of the localized thinning.

Referring now to FIG. 2H, combination of both pitch-catch and pulse-echo working modes using a pair of ultrasonic transducers 160 and 162 to determine depth and location of localized thinning is shown. In FIG. 2H, L_{T1} represents a distance between a localized thinning edge near the first ultrasonic transducer 160 and a centre of the first ultrasonic transducer 160; L_{T2} represents a distance between a localized thinning edge near to the second ultrasonic transducer 162 and a centre of the second ultrasonic transducer 162; L represents a total length of the localized thinning; and D represents a depth of the localized thinning. Procedural step numbers for determination of localized thinning depth and location by combining both pitch-catch and pulse-echo working modes corresponding to the operation procedural steps listed below are indicated in brackets in FIG. 2H:
(1) Conduct pulse-echo working mode for the first ultrasonic transducer 160 to estimate distance between the edge of the localized thinning and the centre of the first ultrasonic transducer 160, L_{T1};
(2) Conduct pulse-echo working mode for the second ultrasonic transducer 162 to estimate distance between the edge of the localized thinning and the centre of the second ultrasonic transducer 162, L_{T2};
(3) Conduct pitch-catch working mode using the first ultrasonic transducer 160 as transmitter and the second ultrasonic transducer 162 as receiver; and
(4) Calculate L using L_{T1} and L_{T2} with Equation (7) below:

$$L = S D - {L}_{T 1} and {L}_{T 2} \qquad ( 7 )$$

where SD represents a separation distance or a centre-to-centre distance of the two ultrasonic transducers 160 and 162; and
(5) Estimate depth of localized thinning by calculating absolute time delay of the selected high-order symmetric Lamb wave mode using Equation (4).

### Example 2

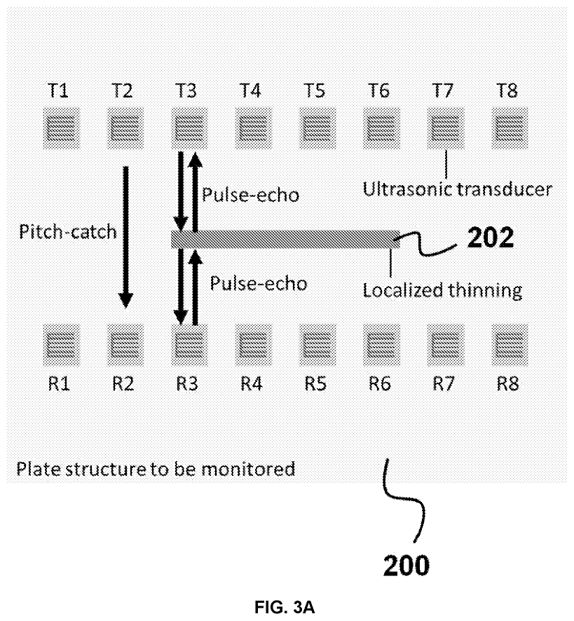

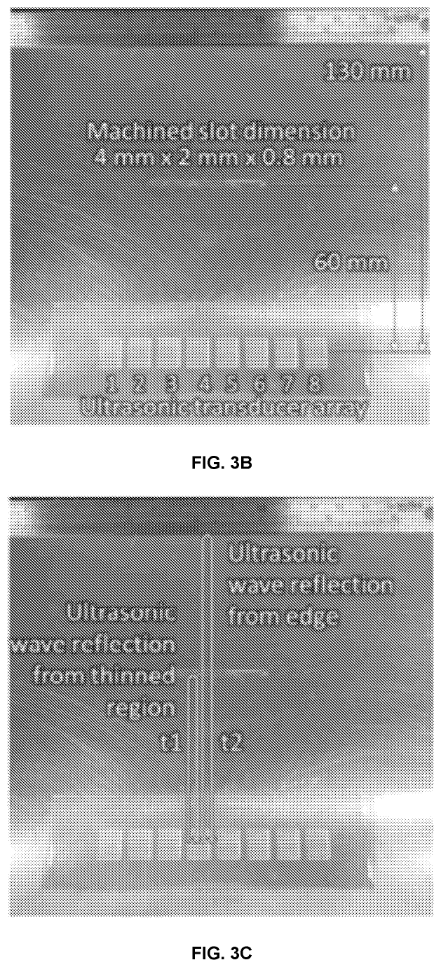

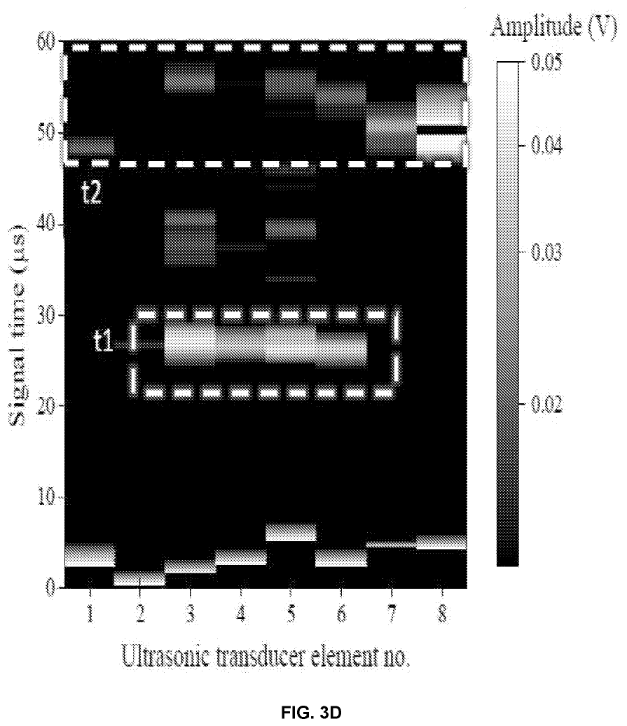

Referring now to FIG. 3A, working modes of a plurality of ultrasonic transducers T1 to T8 and R1 to R8 for determination of depth and location of localized thinning on a large plate structure 200 are shown. To demonstrate location determination of the localized thinning on the large plate structure 200, a linear array made of eight (8) ultrasonic transducers T1 to T8 and R1 to R8 is presented. In this embodiment, eight (8) pairs of in-situ fabricated ultrasonic transducers T1 to T8 and R1 to R8 are formed to two (2) linear arrays to scan a larger area of the plate 200 for estimation of depth and location of the localized thinning. Similar to Example 1, depth and location of the localized thinning is determined using pitch-catch and pulse-echo working mode, respectively, as presented in FIG. 3A. In FIG. 3A, the ultrasonic transducers T1 to T8 are configured as ultrasonic transmitters to generate high-order symmetric Lamb waves and the ultrasonic transducers R1 to R8 are configured as ultrasonic receivers to receive high-order symmetric Lamb waves for pitch-catch working mode. As for pulse-echo working mode, each of the ultrasonic transducers T1 to T8 and R1 to R8 can generate and detect high-order symmetric Lamb waves.

For this demonstration, high-order symmetric Lamb wave S3 mode was selected with the ultrasonic transducers T1 to T8 and R1 to R8 designed using a similar method as described in Example 1. The plate 200, made of an aluminium alloy, had a thickness of 1.6 mm. According to the dispersion curves in FIGS. 2B and 2C, S3 mode can be generated at a frequency of 6.0 MHz with group velocity of 4800 m/s and wavelength of 1.04 mm. A slot 202 with a depth of 0.8 mm was machined to simulate localized thinning. Ultrasonic transducer elements T3 to T6 and R3 to R6 were positioned in the range of the simulated thinned region.

Referring now to FIG. 3B, a photo showing dimensions of an aluminium alloy plate and eight (8) ultrasonic transducer elements is provided. Sequential pulse-echo ultrasonic testing was conducted by transmitting and receiving ultrasonic wave from the ultrasonic transducers in the array, one by one from the same transducer element 1 to 8.

Referring now to FIG. 3C, a photo illustrating pulse-echo working mode using ultrasonic transducer element number 4 as an example is provided.

Referring now to FIG. 3D, a B-scan image showing reflections of the localized thinning edge in t1 and reflections from the edge of the plate in t2 by performing sequential pulse-echo working mode on all the ultrasonic transducer elements in the array is provided. Arrival time of the S3 mode was calculated by considering the round-trip distance where S3 mode was transmitted and reflected from the edge feature of the simulated localized thinned area or the edge of the plate. The pulse-echo arrival time for S3 mode reflected from localized thinned area and the edge of the plate was calculated as 25 μs and 54 μs, respectively. From the results in FIG. 3D, it is clear that by analysing arrival time of the high-order symmetric Lamb wave mode (S3) using linear array in pulse-echo working mode, location of localized thinning can be determined on a large plate structure.

### Example 3

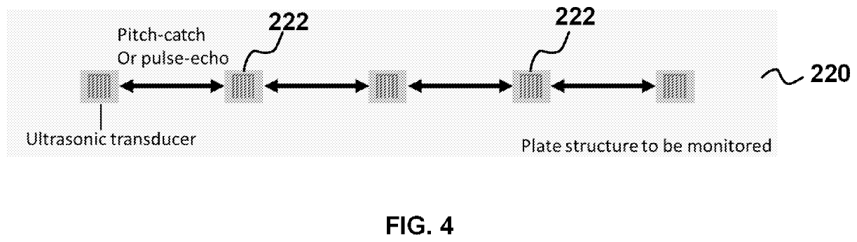

Referring now to FIG. 4, a linear ultrasonic transducer array on a long plate 220 is shown. As can be seen from FIG. 4, a plurality of ultrasonic transducers 222 may form a linear ultrasonic transducer array on the long plate 220 with each ultrasonic transducer 222 being designed using the method described in Example 1. Each of the ultrasonic transducers 222 may conduct pitch-catch and pulse-echo working modes sequentially as shown in FIG. 4. By doing so, positions and depths of multiple localized thinning may be determined on the large plate structure 220. Depth and location determination of multiple localized thinning of the long plate structure 220 is thus possible using the linear ultrasonic transducer array shown in FIG. 4.

### Example 4

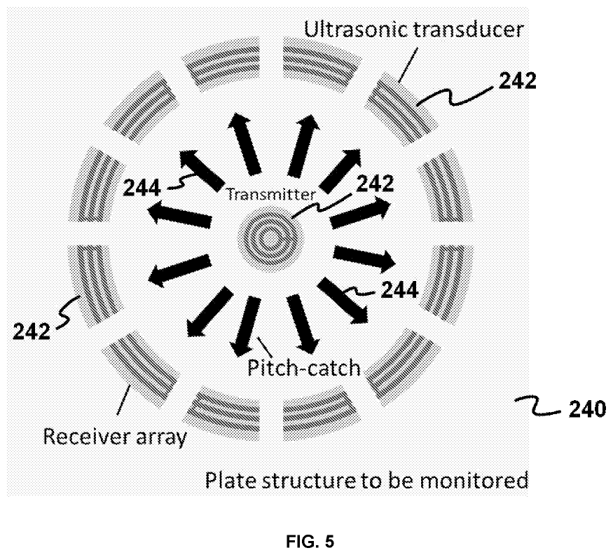

Referring now to FIG. 5, a concentric ultrasonic transducer array on a plate structure 240 is shown. As can be seen from FIG. 5, a plurality of ultrasonic transducers 242 may form a concentric ultrasonic transducer array on the plate structure 240 with each ultrasonic transducer 242 being designed using the method described in Example 1. The ultrasonic transducer 242 at a centre point of the concentric ultrasonic transducer array is able to generate high-order symmetric Lamb waves 244 radially outwards that are detected by the receiver array formed by the ultrasonic transducers 242 as shown in FIG. 5. This working mode is similar to pitch-catch working mode. By analysing arrival time of the selected high-order symmetric Lamb wave mode similarly to Example 1, depth of localized thinning at different locations may be determined. Depth and location determination for multiple localized thinning of the plate structure 240 is thus feasible using the concentric ultrasonic transducer array shown in FIG. 5 for circular array pulse excitation.

As demonstrated by the experiments, localized thinning of plate structures may be effectively detected by analysing signals of high-order symmetric Lamb wave modes.

As is evident from the foregoing discussion, the present invention provides a computer-implemented method for determining depth and location of localised thinning in a plate structure that is applicable to small structures with minimal space constraint due to a reduced design footprint. Advantageously, embodiments of the present invention simplify ultrasonic signal analysis and processing of high-order symmetric Lamb wave modes by selecting a frequency corresponding to the fastest group velocity determined from the group velocity dispersion curve. Further advantageously, in embodiments using a comb electrode transducer design, excitability and detectability of the high-order symmetric Lamb wave modes may be enhanced.

The computer-implemented method for determining depth and location of localised thinning in a plate structure may be applied to monitor localized thinning of various types of plate structures such as, for example, aircraft fuselage or other structural parts, floorboards in safety-critical areas and machine parts in advanced manufacturing.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A computer-implemented method for determining depth and location of localised thinning in a plate structure, comprising executing on one or more processors the steps of:
selecting a high-order symmetric Lamb wave mode;
generating the selected high-order symmetric Lamb wave mode in the plate structure using one or more first ultrasonic transducers attached to the plate structure;
detecting the generated high-order symmetric Lamb wave mode using the one or more first ultrasonic transducers or one or more second ultrasonic transducers attached to the plate structure;
comparing arrival times of the detected high-order symmetric Lamb wave mode with a set of baseline signals to determine the depth of the localised thinning in the plate structure; and
analysing the arrival times of the detected high-order symmetric Lamb wave mode reflected from an edge of the localised thinning to determine the location of the localised thinning in the plate structure.

2. The computer-implemented method for determining depth and location of localised thinning in the plate structure according to claim 1, wherein the step of selecting the high-order symmetric Lamb wave mode comprises:
obtaining group velocity dispersion curves of Lamb wave modes based on plate material and plate thickness.

3. The computer-implemented method for determining depth and location of localised thinning in the plate structure according to claim 2, wherein the step of selecting the high-order symmetric Lamb wave mode further comprises:
determining fastest group velocities from the group velocity dispersion curves of the plate structure.

4. The computer-implemented method for determining depth and location of localised thinning in the plate structure according to claim 3, wherein the step of selecting the high-order symmetric Lamb wave mode further comprises:
selecting a frequency for the high-order symmetric Lamb wave mode based on the fastest group velocities from the group velocity dispersion curves of the plate structure.

5. The computer-implemented method for determining depth and location of localised thinning in the plate structure according to claim 1, wherein a wavelength of the selected high-order symmetric Lamb wave mode corresponds to a periodicity of a comb-shaped electrode of at least one of the one or more first ultrasonic transducers and the one or more second ultrasonic transducers.

6. The computer-implemented method for determining depth and location of localised thinning in the plate structure according to claim 1, wherein the step of comparing the arrival times of the detected high-order symmetric Lamb wave mode with the set of baseline signals comprises:
generating the set of baseline signals representing an initial state of the plate structure.

7. The computer-implemented method for determining depth and location of localised thinning in the plate structure according to claim 6, wherein the step of generating the baseline signal comprises:
applying electrical driving signals at a selected frequency to the one or more first ultrasonic transducers attached to the plate structure to generate a plurality of high-order symmetric Lamb waves in the selected high-order symmetric Lamb wave mode.

8. The computer-implemented method for determining depth and location of localised thinning in the plate structure according to claim 7, wherein the step of generating the baseline signal further comprises:
detecting the high-order symmetric Lamb waves at the one or more first ultrasonic transducers via a pulse-echo working mode.

9. The computer-implemented method for determining depth and location of localised thinning in the plate structure according to claim 7, wherein the step of generating the baseline signal further comprises:
detecting the high-order symmetric Lamb waves at the one or more second ultrasonic transducers via a pitch-catch working mode.

10. The computer-implemented method for determining depth and location of localised thinning in the plate structure according to claim 1, wherein the first ultrasonic transducers and the second ultrasonic transducers are arranged to form one or more linear arrays on the plate structure.

11. The computer-implemented method for determining depth and location of localised thinning in the plate structure according to claim 1, wherein the second ultrasonic transducers are arranged to form a concentric array on the plate structure.
